(19) United States
(12) Patent Application Publication
(10) Pub. No.: US 2010/0271331 A1
(43) Pub. Date: Oct. 28, 2010

(54) Touch-Screen and Method for an Electronic Device

(76) Inventors: Rachid Alameh, Crystal Lake, IL (US); Roger Ady, Chicago, IL (US); Dale Bengtson, Crystal Lake, IL (US); Ricky J. Hoobler, Lake Bluff, IL (US); Jin Kim, Pleasant Prairie, WI (US); Jeffrey Olson, San Francisco, CA (US)

Correspondence Address: PHILIP H. BURRUS, IV, 460 Grant Street, Atlanta, GA, 30312, US

(21) Appl. No.: 12/428,266

(22) Filed: Apr. 22, 2009

(51) Int. Cl. G06F 3/042; G06F 3/048

(52) U.S. Cl. 345/175; 715/811; 345/207

(57) ABSTRACT

A touch sensitive display for an electronic device includes a display (201) for presenting information to a user and at least four infrared transceivers (202,203,204,205) disposed about the display (201). The four or more infrared transceivers (202,203,204,205) can be disposed about the display (201) such that infrared light (206,207,208,209) from each of the infrared transceivers (202,203,204,205) projects across a surface (303) of the display (201). A controller (214), which is operable with the infrared transceivers (202,203,204,205), is configured to detect which of the infrared transceivers (202,203,204,205) has the most reflected signal (702). The controller (214) can then correlate this and other information with one of a plurality of user modes of operation. A control menu (802) can then be presented on the display (301) in accordance with the user mode of operation to mitigate finger blockage.

### CROSS REFERENCE TO RELATED APPLICATIONS

This application is related to U.S. Ser. No. ______, entitled “Menu Configuration System and Method for Display on an Electronic Device,” filed ______, attorney docket No. BPCUR0097RA (CS35973), which is incorporated herein by reference.

### BACKGROUND

1. Technical Field

This invention relates generally to touch sensitive user interfaces for electronic devices, and more particularly to a system and method for presenting user actuation targets on a display that compliment a user mode of operation.

2. Background Art

Portable electronic devices, including mobile telephones, music and multimedia players, gaming devices, personal digital assistants, and the like are becoming increasingly commonplace. People use these devices to stay connected with others, to organize their lives, and to entertain themselves. Advances in technology have made these devices easier to use. For example, while these devices used to have a dedicated display for presenting information and a keypad for receiving input from a user, the advent of “touch-sensitive screens” have combined the display and keypad. Rather than typing on a keypad, a user simply touches the display to enter data. Touch-sensitive displays, in addition to being dynamically configurable, allow for more streamlined devices that are sometimes preferred by consumers.

One problem associated with electronic devices having touch-sensitive screens is “finger blockage.” When a user places a finger on a touch-sensitive display to actuate an icon or control, the user's finger and hand invariably covers at least a portion of the display, rendering that portion of the display unviewable. Consequently, to launch a program or perform a task, the user may have to actuate a first icon on the touch-sensitive screen, completely remove their hand to see the screen, actuate a second icon, completely remove their hand again, and so forth.

There is thus a need for an improved electronic device that has a touch-sensitive screen that mitigates finger blockage problems.

### BRIEF DESCRIPTION OF THE DRAWINGS

FIG. 1 illustrates finger blockage.

FIG. 2 illustrates one touch sensitive display in accordance with embodiments of the invention.

FIG. 3 illustrates another view of one touch sensitive display in accordance with embodiments of the invention.

FIGS. 4-6 illustrate view of exemplary touch sensitive displays in accordance with embodiments of the invention.

FIG. 7 illustrates one touch sensitive display in accordance with embodiments of the invention.

FIGS. 8-11 illustrate control menu displays on exemplary displays in accordance with embodiments of the invention.

FIG. 12 illustrates motion detection and control menu display on one display in accordance with embodiments of the invention.

FIGS. 13-14 illustrate schematic block diagrams of circuits operable with infrared transceivers in accordance with embodiments of the invention.

FIGS. 15-17 illustrate methods for touch sensitive displays in accordance with embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to determining placement of a user's finger or stylus on a touch-sensitive display, correlating that position to a mode of use, and presenting information to the user in a manner corresponding to that mode of use to mitigate finger blockage. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional processors, computer readable media, and unique stored program instructions that control the one or more processors to implement, in conjunction with certain non-processor circuits, some, most, or all of the functions of determining placement of a user's finger or stylus on a touch-sensitive display, correlating that position to a mode of use, and presenting information or user actuation targets in a manner that corresponds to the mode of use as described herein. As such, these functions may be interpreted as steps of a method to perform the determination of the placement or motion of a user's finger or stylus on a touch-sensitive display and the presentation of menus, information, and user actuation targets so as to correspond with the placement or motion of the user's finger or stylus. Alternatively, some or all functions could be implemented by a state machine that has no stored program instructions, or in one or more application specific integrated circuits, in which each function or some combinations of certain of the functions are implemented as custom logic. Of course, a combination of the two approaches could be used. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and circuits with minimal experimentation.

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Due to finger blockage issues discussed above, there is a need to adaptively display all icons, menus, information, or user actuation targets in a manner that corresponds with a particular user's mode of operation of an electronic device. Embodiments of the present invention provide such a display and method, in that icons, menus, information, or user actuation targets can be presented such that these elements are minimally obstructed by the user's finger, hand, or stylus location, thereby enhancing the user's overall experience with the device.

Embodiments of the present invention provide an infrared touch-screen for an electronic device that includes an object detection system that detects the location of a finger, stylus, or other object along the touch screen. Embodiments of the invention can then correlate that location with a particular mode of use, and can present user actuatable objects and information on the display that minimizes finger blockage and optimizes content placement. Further, where a user operates a particular device with one hand, such as by left-handed operation or right-handed operation, embodiments of the present invention can detect such operation and provide information to the user in a manner that is complimentary to this mode of use.

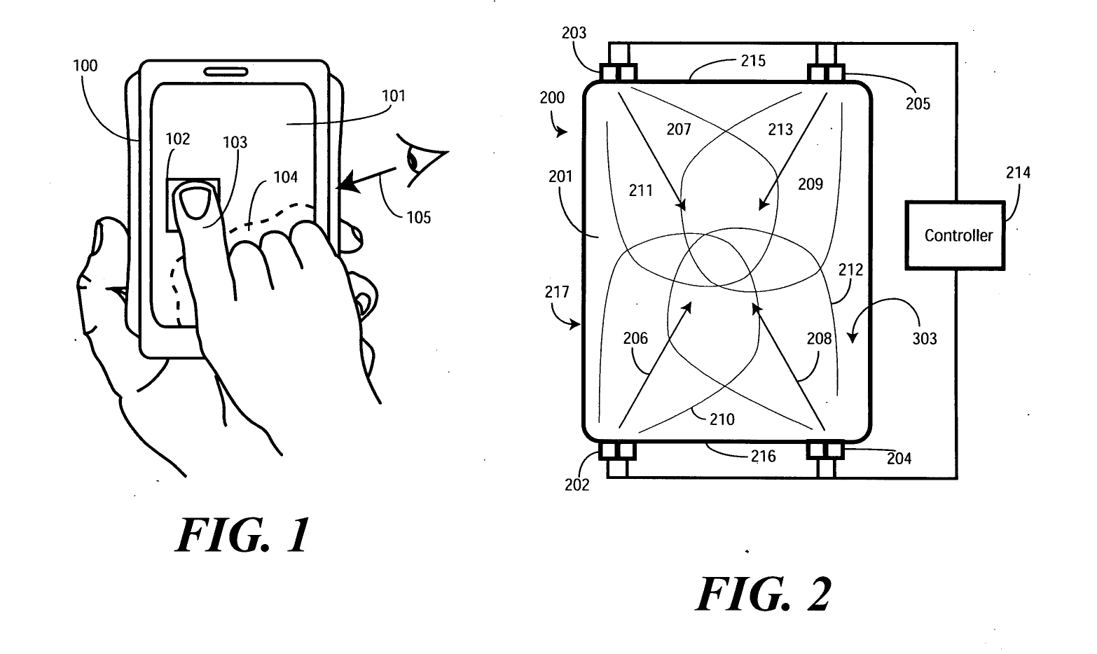

Turning now to FIG. 1, illustrated therein is a problem that can occur with electronic devices 100 employing touch sensitive displays 101. Specifically, when a user is actuating a user actuation target 102 with a finger 103 or other object, a significant portion 104 of the touch sensitive display 101 can be blocked from the user's line of sight 105.

This problem can be especially frustrating when a user actuates an icon and a “sub-menu” is presented. For example, if the user is trying to manipulate a particular item in the electronic device 100, upon selecting the item, the user may be given several optional choices from which to select. These choices may include “save,” “print,” “e-mail,” and so forth. If that sub-menu is presented in the blocked portion 104 of the touch sensitive display 101, the user will be unable to see it unless they completely remove their hand from the device.

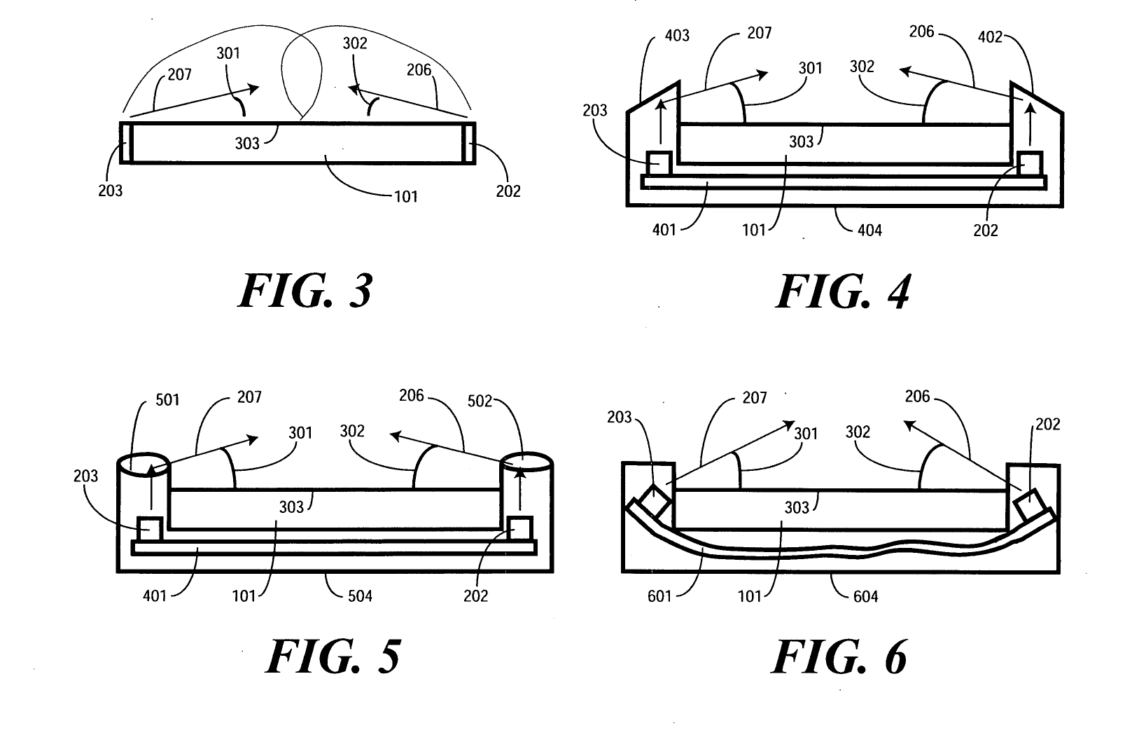

Turning now to FIG. 2, illustrated therein is one embodiment of an infrared detector 200 that, when used in accordance with embodiments of the invention, helps resolve the issue depicted in FIG. 1. The touch sensitive interface 200 includes a display 201 for presenting information to a user. About the display are disposed at least four infrared transceivers 202,203,204,205. While at least four transceivers will be used herein as an illustrative embodiment, it will be clear to those of ordinary skill in the art having the benefit of this disclosure that the invention is not so limited. Additional transceivers may be disposed about the display 101 as needed by a particular application. Additionally, while a square or rectangular display 101 is shown herein for discussion purposes, the invention is not so limited. The display 101 could have any number of sides, could be round, or could be a non-uniform shape as well.

Each infrared transceiver 202,203,204,205 can be a transmitter-receiver pair. Such a configuration is illustratively shown in FIG. 2 - each infrared transceiver 202,203,204,205 is shown as a light emitting element and a light receiving element. Alternatively, each infrared transceiver 202,203,204,205 could be a single transceiver. Semiconductor infrared transceiver devices are well known in the art and are available from a variety of manufacturers.

In the illustrative embodiment of FIG. 2, each infrared transceiver 202,203,204,205 is disposed about the display such that infrared light 206,207,208,209 is projected across a surface of the display. For example, infrared light 206 projects across the surface of the display 101 from infrared transceiver 202, while infrared light 207 projects across the surface of the display 101 from infrared transceiver 203. Similarly, infrared light 208 projects across the surface of the display 101 from infrared transceiver 204, while infrared light 209 projects across the surface of the display 101 from infrared transceiver 205.

Light coverage rings 210,211,212,213 show illustrative directivity patterns from each of the infrared transceivers 202,203,204,205. These light coverage rings 210,211,212,213 are shown to provide an illustration of the directions and directivity with which each infrared transceiver projects light. They do not depict the full coverage of light emitted or received by any of the transceivers. The full surface of the display 101 can be more than covered by four infrared transceivers 202,203,204,205. As shown by the illustrative embodiment of FIG. 2, in one embodiment, the infrared transceivers 202,203,204,205 are disposed such that the infrared light 206,207,208,209 intersects with light from other infrared transceivers 202,203,204,205 within a perimeter 217 of the display 101.

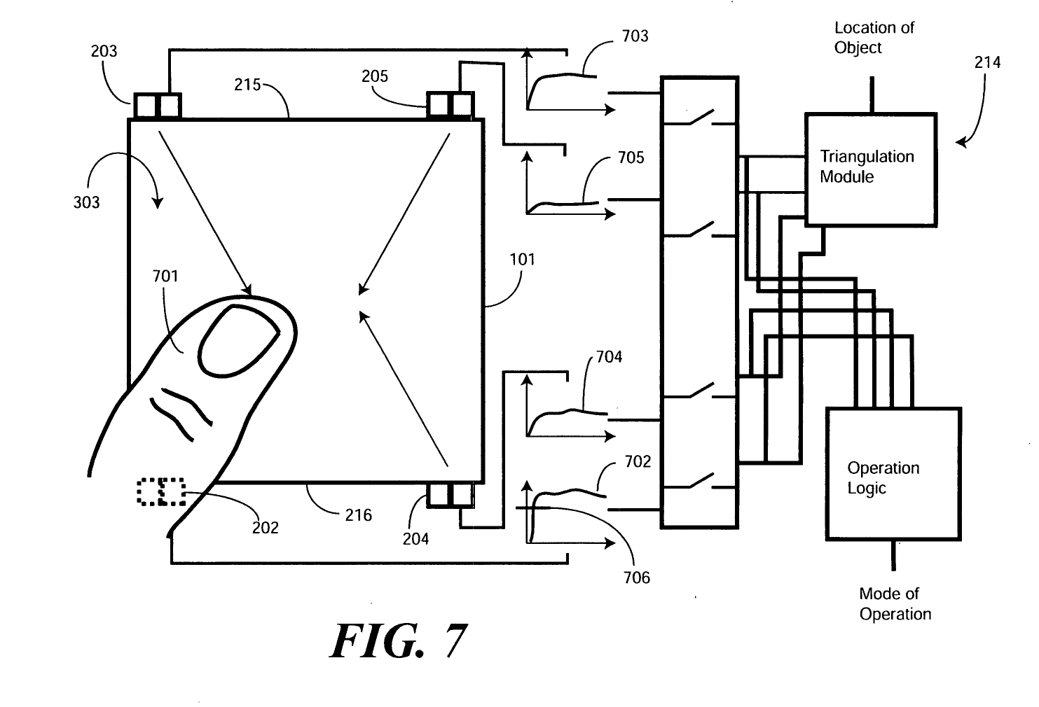

In one embodiment each of the infrared transceivers is configured to project light at an angle relative to the surface of the display. Turning briefly to FIG. 3, such a configuration can be seen. Specifically, FIG. 3 shows a side, elevation view of the display 101 with the infrared transceivers 202,203 disposed such that each transceiver projects infrared light 206,207 at an acute angle 301,302 relative to the surface 303 of the display. Note that as FIG. 3 illustrates a side elevation view, only two infrared transceivers 202,203 are visible from the four infrared transceivers, although at least four are present.

Such an orientation of the infrared transceivers 202,203 helps to maximize infrared object detection by concentrating the infrared light 206,207 towards the surface 303 of the display 101 where it is most useful. The infrared light 206,207 transmitted by the light emitting elements of the infrared transceivers 202,203 is kept close to the surface 303 and is not lost by directing it substantially upward.

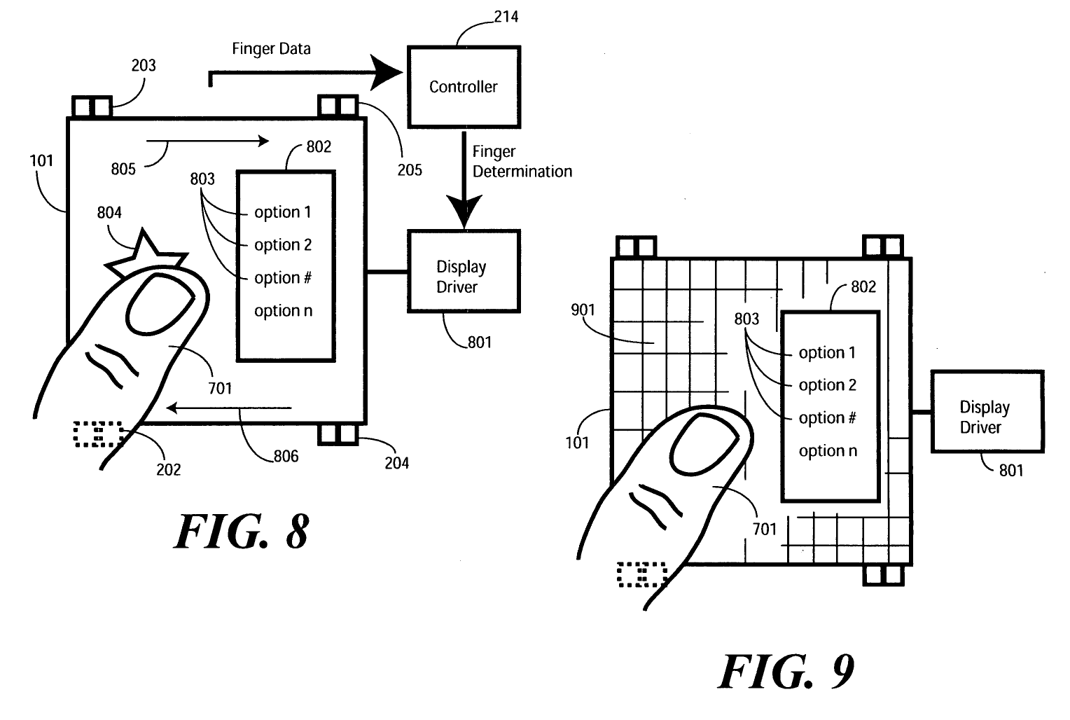

This inward tilt of the infrared transceivers can be accomplished in a variety of ways. Three possible ways of accomplishing this tilt are illustratively shown in FIGS. 4, 5, and 6. Turning first to FIG. 4, illustrated therein is one embodiment with which infrared light 206,207 can be directed at an angle 301,302 relative to the surface 303 of the display 101. In FIG. 4, the infrared transceivers 202,203 are mounted on a printed circuit board 401 disposed within a housing 404 of the electronic device. Each light emitting element of each infrared transceiver 202,203 projects infrared light 206,207 upward, where it is reflected from a corresponding reflector 402,403. These reflectors 402,403 redirect the light at angles 301,302 relative to the surface 303 of the display 101.

Turning next to FIG. 5, illustrated therein is another embodiment with which infrared light 206,207 can be directed an angle 301,302 relative to the surface 303 of the display 101. In FIG. 5, the infrared transceivers 202,203 are mounted on a printed circuit board 401 disposed within a housing 504 of the electronic device. Each light emitting element of each infrared transceiver 202,203 projects infrared light 206,207 upward, where it is redirected through a corresponding lens 501,502. The lenses 501,502 redirect the light at angles 301,302 relative to the surface 303 of the display 101.

Turning now to FIG. 6, a lower-cost embodiment is shown with which infrared light 206,207 can be directed at an angle 301,302 relative to the surface 303 of the display 101. In FIG. 6, the infrared transceivers 202,203 are mounted on a flexible circuit substrate 601 which can bend and conform to the surface it is held against. The housing 604 of FIG. 6 is designed to hold the flexible circuit substrate 601 with the ends at angles relative to the surface 303 of the display 101. Consequently, when the infrared light 206,207 is projected from the infrared transceivers 202,203, it is projected at angles 301,302 relative to the surface 303 of the display 101.

Turning now back to FIG. 2, a controller 214 is operable with the infrared transceivers 202,203,204,205. The controller 214, which may be a microprocessor, programmable logic, application specific integrated circuit device, or other similar device, is capable of executing program instructions which may be stored either in the controller 214 or in a memory or computer readable medium (not shown) coupled to the controller 214.

The controller 214 is configured to detect which of the four infrared transceivers 202,203,204,205 receives a most reflected light signal. As the light emitting elements of each infrared transceiver 202,203,204,205 emit infrared light 206,207,208,209, that infrared light 206,207,208,209 is reflected of objects such as fingers and stylus devices that are proximately located with the surface 303 of the display 101. Where each light receiving element of the infrared transceivers 202,203,204,205 receives light having approximately the same signal strength, the controller 214 is configured to correlate this with the object being located relatively within the center of the display 101. Where, however, one infrared transceiver 202,203,204,205 receives a highest received signal, or, in an alternate embodiment a received signal above a predetermined threshold, the controller 214 is configured to correlate this with a finger or other object being located near or atop that particular infrared transceiver.

As will be described below, where the controller 214 determines that a finger or other object is near or atop a particular infrared transceiver, that information can be used to correlate the object's location with a particular mode of operation. For example, in the illustrative embodiment of FIG. 2, the display 101 has two infrared transceivers 202,204 disposed along the bottom 216 of the display 101, while two infrared transceivers 203,205 are disposed along the top 215 of the display 101. Where the electronic device is being held upright by the user, and an infrared transceiver 202,204 disposed along the bottom 216 of the display 101 is receiving the most reflected signal, it can mean that user is operating the display 101 with their thumbs. Where the infrared transceiver 202,204 receiving the most reflected signal is the infrared transceiver 202 on the lower, left corner of the display 101, this can indicate a user operating the display 101 with one hand, and more particularly the left hand. Where the infrared transceiver 202,204 receiving the most reflected signal is the infrared transceiver 204 on the lower, right corner of the display 101, this can indicate a user operating the display 101 with one hand, and more particularly the right hand.

Where the user is employing one-handed operation, and further where the user is using the thumb to operate the display 101, this can pose substantial blockage issues. As the thumb is a relatively thick digit, it can block large portions of the display 101. Further, as the thumb tends to be a short digit, it is more cumbersome to move out of the way than, say, an index finger. Further, the base of the thumb covers a portion of the display 101 toward the bottom 216 (or essentially directly contacts it) while the tip of the thumb touches a different part of the display 101.

Embodiments of the present invention recognize that when a thumb or base of the thumb is atop an infrared transceiver, the reflected signal at that infrared transceiver will be at a high or saturated level. Further, when a finger is atop a particular infrared transceiver, the reflected signals at infrared transceivers disposed opposite the display will have a small or minimal signal. Using the configuration of FIG. 2 as an example, when a finger is atop infrared transceiver 202, its received signal will be near saturation, while the received signals at infrared transceivers 204,205 will be much smaller or minimal. Where the controller 214 is programmed with such reference information, it can correlate object position relative to the display 101 with a particular user mode of operation, such as one-handed operation, two-handed operation, left-handed single hand operation, right-handed single hand operation, and so forth.

Once the user mode of operation is determined, in one embodiment, the controller 214 can configure the electronic device to operate in a manner corresponding to the mode of operation. Operational states of the electronic device can include directing audio in a particular direction, polarizing the screen in a particular direction, enabling certain keys, and so forth.

By way of example, if the controller 214 determines the user is employing left-handed mode of operation, the controller 214 may cause audio to be directed to the left side. Similarly, the controller 214 may cause the display to be polarized for optimum viewability or optimum privacy from the left side of the display. In another embodiment, the controller 214 may polarize the display to show content to the user on the left side. The controller 214 may cause user icons or keys that are more easily accessible by the right hand to change location so as to be more easily accessible by the left, and so forth.

In one embodiment of the invention, a finer resolution of the location of the object is required. This can be accomplished by triangulation between the various infrared transceivers 202,203,204,205. Triangulation to determine an object's location by reflecting transmitted waves off the object is well known in the art. Essentially, in triangulation, the infrared transceivers are able to determine the location of a user's finger, stylus, or other object by measuring angles to that object from known points across the display along a fixed baseline. The user's finger, stylus, or other object can then be used as the third point of a triangle with the other vertices known.

Where a finger or object is atop a particular infrared transceiver, as indicated by a transceiver having a most received signal or a signal above a predetermined threshold, this transceiver is generally not suitable for triangulation purposes. As such, in accordance with embodiments of the invention, upon determining an infrared transceiver receiving a most reflected light signal, the controller 214 can be configured to determine the objects location by triangulation using only infrared transceivers other than the one receiving the most reflected signal. In the illustrative embodiment of FIG. 2, wherein infrared transceiver 202 is receiving the most reflected signal, the controller 214 can be configured to determine the corresponding object's location by triangulation using infrared transceivers 203,204,205. Note that the four transceiver example of FIG. 2 can easily be extended to more than four transceivers. When a finger blocks one transceiver, the others are used for location detection.

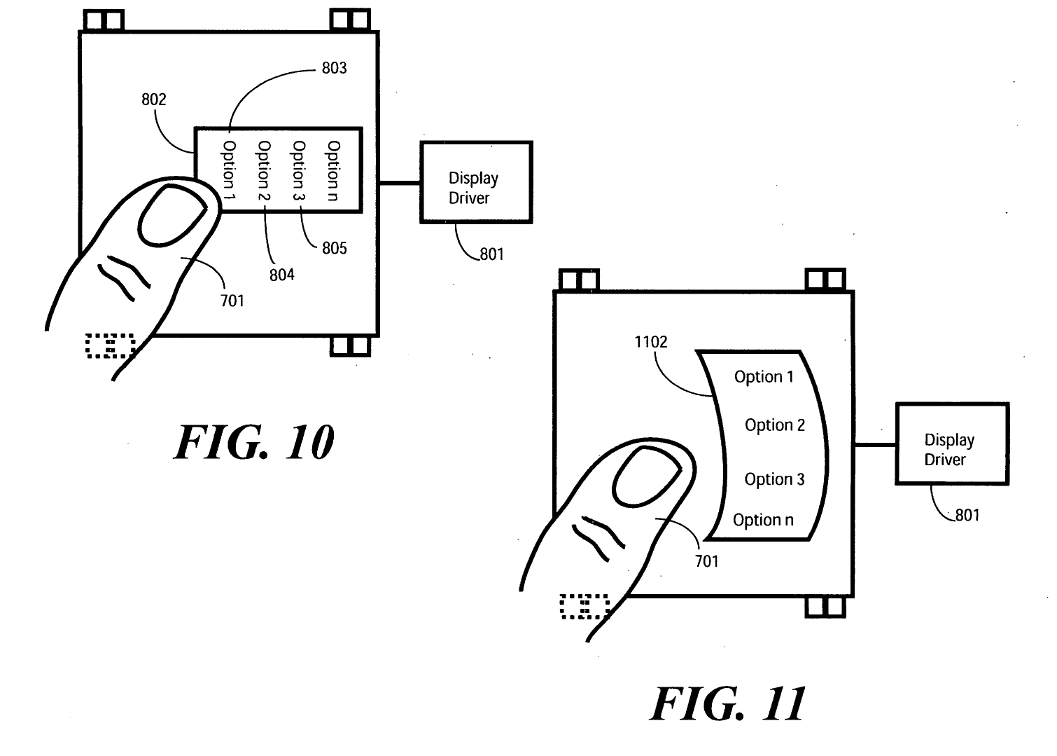

Turning now to FIG. 7, illustrated therein is an example of a display 101 for presenting information to a user with at least four infrared transceivers 202,203,204,205 disposed about the display 101 such that light from the infrared transceivers 202,203,204,205 is projected across the surface 303 of the display 101. In FIG. 7, a user's thumb 701 is generally atop infrared transceiver 202, as the user is employing a one-handed, left-handed, mode of operation. In this configuration, infrared transceiver 202 is suffering from “thumb blockage.”

The controller 214 is configured to detect this by detecting which of the infrared transceivers 202,203,204,205 is receives a most reflected signal 704. As shown in FIG. 7, each of the infrared transceivers 202,203,204,205 delivers a corresponding signal 702,703,704,705 to the controller 214. In the embodiment of FIG. 7, as the thumb 701 is atop infrared transceiver 202, it receives the most reflected signal 702.

The most reflected signal 702 can be detected in a variety of ways. First, the most reflected signal 702 may simply be the signal that has a magnitude greater than the other signals 703,704,705. Second, the most reflected signal 702 may be a signal that is above a predetermined threshold 706. Third, the most reflected signal 702 may be a signal that is at or near saturation, or that is driven to the rail of the component. Of course, a combination of these approaches can also be used. For example, in one embodiment the controller 214 is configured to determine the most reflected signal 702 by determining which of the signals 702,703,704,705 is the strongest, and then determining whether that signal is above a predetermined threshold 706, such as a predetermine number of volts or a predetermined bit code, where analog to digital conversion is employed.

Once the most reflected signal 702 is determined, this information can be used to correlate with one of a plurality of modes of operation. For example, a user can operate a device with two hands in three ways: First, the user can hold the device with the left hand and operate the display 101 with the right. Second, the user can hold the device with the right hand and operate the display 101 with the left. Third, the user can hold the device equally with both hands and operate the display 101 with fingers from each hand. Similarly, the user can operate the device with one hand in two ways, right handed or left handed.

Where the controller 214 determines that infrared transceiver 202 corresponds to the most reflected signal 702, or where the controller 214 determines which of the bottom infrared transceivers 202,204 receives the most reflected signal 702, or where the controller 214 determines that infrared transceiver 202 corresponds to the most reflected signal 702 for at least a predetermined time, the controller 214, in one embodiment, correlates this with a particular mode of operation. For instance, in the illustrative embodiment of FIG. 7, the controller 214 may correlate this with one-handed, left-handed operation.

Illustrating by way of another example, in one embodiment the controller 214 is configured to determine which of the infrared transceivers 202,204 disposed along the bottom 216 of the display 101 corresponds to the most reflected signal 702. Such a configuration is desirable in detecting single-handed right or left handed operation.

In one embodiment, rather than simply determining which of the infrared transceivers 202,203,204,205 corresponds to the most reflected signal 702, the controller 214 may be configured with additional procedures. For example, the controller 214 may be configured to first detect which of the infrared transceivers 202,204 disposed along the bottom 216 of the display 101 corresponds to the most reflected signal 702. Upon doing this, the controller 214 can be configures to determine which of the infrared transceivers 203,205 disposed along the top 215 of the display 101 receives the most reflected light signal of the two. In the illustrative embodiment of FIG. 7, infrared transceiver 203 receives a greater signal 703 than does infrared transceiver 705, as it is closer to the user's thumb 701. This second check adds resolution to the correlation with a particular mode of operation. In this example, as the infrared transceivers 202,203 receiving the stronger signals are on the left side of the display 101, the controller 214 may correlate to left-handed use. The opposite of course could be true—where the controller 214 detects that the infrared transceiver disposed along the bottom 216 of the display 101 receiving the most reflected signal is infrared transceiver 204, and the infrared transceiver disposed along the top 215 of the display 101 corresponding to the higher signal is infrared transceiver 205, the controller 214 can correlate this configuration with single-handed, right-handed operation.

In one embodiment, in addition to correlating infrared transceiver operation with a user mode of operation, the infrared detector is capable of determining the location of the finger 701 or other object as well. One suitable method for determining this location is by triangulating the location of the thumb 701 with infrared transceivers other than that receiving the most reflected signal 702. Thus, in the configuration of FIG. 7, upon the controller 214 determining that infrared transceiver 202 corresponds to the most reflected signal 702, the controller 214 can be configured to determine the location of the thumb 701 by triangulation using infrared transceivers 203,204,205. Said differently, the controller 214 is configured to determine the location of the thumb 701 along the surface 303 of the display 101 by triangulation using signals 703,704,705 from three infrared transceivers 203,204,205 of the four infrared transceivers 202,203,204,205, where the three infrared transceivers 203,204,205 does not include the infrared transceiver 202 receiving the most reflected signal 702.

Illustrating additional modes of operation, in one embodiment, the controller 214 determines which of the two infrared transceivers 202,204 disposed along the bottom 216 of the display 101 is receiving the higher signal. This is then compared with a determination of which of the two infrared transceivers 203,205 disposed along the top 215 of the display 101 is receiving the higher signal. If infrared transceivers 202 and 203 are receiving the higher signals, the controller 214 can be configures to correlate this configuration with single-handed, left-handed operation, where infrared transceiver 202 receives the most reflected signal. If transceivers 204 and 205 are receiving the higher signals, the controller 214 can be configures to correlate this configuration with single-handed, right-handed operation, where infrared transceiver 204 receives the most reflected signal.

Where lower infrared transceivers 202,204 have a corresponding high reflected signal, while upper infrared transceivers 203,205 have a corresponding low reflected signal, the controller 214 can be configured to conclude that thumb operation has been predicted accurately, i.e., that thumb 701 is not extending between in from a side of the display 101, but rather from the bottom. In such a configuration, blockage may be minimal in that the thumb 701 extends in from the bottom 216 of the display 101 rather than from the sides.

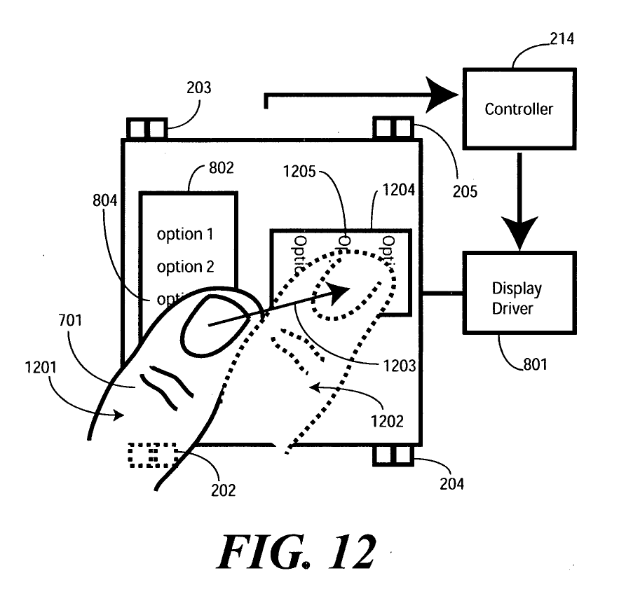

Once a particular mode of operation has been correlated by the controller 214, this information can be used with the presentation of additional information to keep the additional information out—as much as possible—of regions that a user cannot see due to blockage issues. Turning now to FIG. 8, illustrated therein is one such presentation of data.

In FIG. 8, the controller 214 has determined that the user mode of operation is single-handed, left-handed operation. This is evidenced by the user's thumb 701 being atop infrared transceiver 202, which results in infrared transceiver 202 corresponding to the most reflected signal.

This information is then fed to a display driver 801, which is operable with the controller 214 and is configured to present a control menu 802 on the display 101. In the illustrative embodiment of FIG. 8, the control menu 802 includes a plurality of user selectable options 803, and is responsive to the user actuating a user actuation target 804. As such, in this illustrative embodiment, the control menu 802 is a sub-menu, as it is presented in response to a primary user actuation.

To avoid blockage issues, in one embodiment the display driver 801 is configured to present the control menu 802 on a portion of the display 101 disposed distally from the infrared transceiver 202 receiving the most reflected light signal. In FIG. 8, the control menu 802 may be presented towards the upper, right side of the display 101. By presenting the control menu 802 distally from the user's thumb 701, it is less likely that a portion of the control menu 802 will be obstructed by the user's thumb 701, thereby rendering it more visible to the user.

By way of example, as the controller 214 has determined that the user is employing left-handed operation, perhaps by correlation of a pair of infrared transceivers 202,203 receiving the most reflected light signals being on the left side of the display 101, in one embodiment the display driver 801 is configured to present the control menu 802 on a right-side portion 805 of the display 101. Of course the opposite could be true—where the controller 214 correlates the pair of infrared transceivers 204,205 receiving the most reflected light signals to be on the right side of the display 101, the display driver 801 can be configured to present the control menu 802 on the left-side portion 806 of the display 101. Note that the right-side portion 805 and left-side portion 806 need not be to one side of a median—they can instead be portions of the display 101 that are towards one side of the display 101 or the other, depending upon application.

Turning now to FIG. 9, illustrated therein is another positioning of a control menu 802 to mitigate finger blockage issues. In the embodiment of FIG. 9, the display 101 has been divided into a plurality of surface area segments 901. The surface area segments 901 can then be correlated with corresponding infrared transceivers. For example, two, three, four, eight, ten, or another number of surface area segments 901 can be correlated with one infrared transceivers, while two, three, four, eight, ten, or another number of surface area segments 901 can be correlated with another infrared transceiver. When this is done, and an object such as the user's thumb 701 is detected blocking one of the infrared transceivers, the display driver 801 can be configured to present the control menu 802 in surface area segments other than those segments corresponding to the blocked infrared transceiver. This helps to mitigate blocking issues.

In addition to determining where to present the control menu 802, the display driver 801 can further be configured to determine advantageous ways to display the various options 803 of the control menu as well. Turning now to FIG. 10, illustrated therein is one example of an advantageous control menu 802 display in accordance with embodiments of the invention.

With some control menus 802, there will be too many options 803,804,805 to display. Portable electronic devices frequently have small screens. As such, if a particular control menu 802 has too many options 803,804,805 to display with sufficient resolution, embodiments of the present invention offer ways to make certain options more readily accessible to the user than others. For instance, in one embodiment, the display driver 801 is configured to present options that have been more recently selected closer to the user's thumb 701 than other options. Thus, in the illustrative embodiment of FIG. 10, option 803 may be the most recently selected option, while option 804 is the next most recently selection option. Option 805 may be a “more” option that, when selected, shows additional options not shown in the first control menu 802. Note that while most recently selected may be one criterion for organizing options, it will be clear to those of ordinary skill in the art having the benefit of this disclosure that the invention is not so limited. Other factors, such as most frequently selected option, may also be used to determine which option is presented closest to the user's thumb 701.

In addition to determining where to present the control menu 802, and determining in what order to display various options 803,804,805, the display driver 801 can further be configured to determine advantageous geometric ways to display the various options 80 of the control menu as well. Turning now to FIG. 11, illustrated therein is one example of an advantageous geometrically oriented control menu 1102 display in accordance with embodiments of the invention. In FIG. 11, the display driver 801 is configured to present the control menu 1102 about the user's thumb 701 in a curved configuration. Such a configuration can make it possible to present more options to the user within the confines of the display's surface area. Note that while a partially-circular pattern is shown for the control menu 1102 of FIG. 11, this embodiment is illustrative only, as it will be clear to one of ordinary skill in the art having the benefit of this disclosure that the invention is not so limited. Other configurations, including partially-oval, semicircular, spiral, flower-petal, circular, and the like may also be used. This particular configuration of the control menu 1102 can be more efficient in that selection of options generally requires shorter travel to the desired selection.

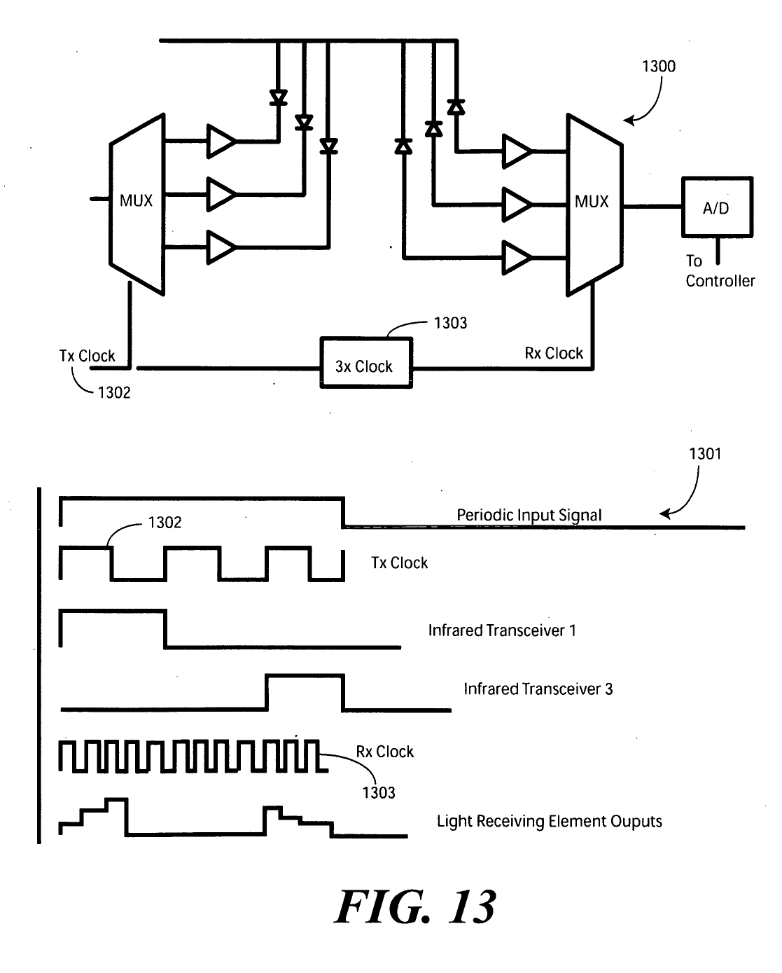

Turning now to FIG. 12, illustrated therein is a diagram of motion detection in accordance with embodiments of the invention. In one embodiment, in addition to determining the initial location 1201 of a user's finger 701 by triangulation of infrared transceivers 203,204,205 other than the infrared transceiver 204 receiving the most reflected signal, the controller 214 is also configured to determine motion 1203 of that object. In one embodiment, the controller 214 is configured to determine the movement 1203 of the object by repeatedly triangulating the object.

In the illustrative embodiment of FIG. 12, as infrared transceiver 202 initially received the most reflected signal, the controller 214 uses infrared transceivers 203,204,205 to determine the initial location 1201 of the user's finger 701. The controller 214 is then configured to repeatedly triangulate signals received by these infrared transceivers 203,204,205 to determine movement 1203 of the user's finger along the display surface 303.

Motion detection in this configuration offers ease of use advantages to the user. By way of example, in one embodiment, when a control menu 802 or other user actuation target is available to the user, and the user makes a selection by touching either the user actuation target or a sub-portion 804 of the control menu 802, the display driver is configured to present a second control menu 1204 to the user with additional options. The user is then able to select one of the options 1205 simply by sliding his finger 701 to a second position 1202 on the display surface 303, which corresponds to a sub-portion of the second control menu 1205. Such a move is simpler ergonomically than having to lift the finger 701 and tap the menu option 804. Further, the infrared transceivers 203,204,205 can determine the user's actuation of the menu option 804 without the need of an additional pressure or touch sensor.

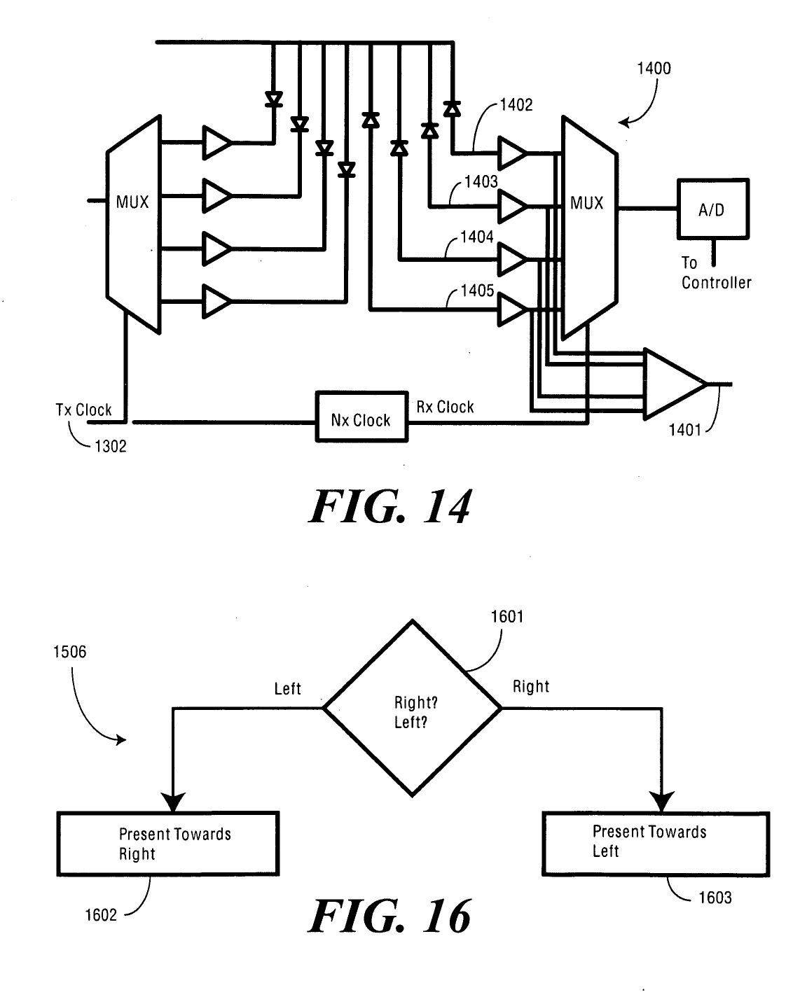

In one embodiment, rather than actuating each infrared transceiver 202,203,204,205 on continually or simultaneously, it is preferable to actuate the infrared transceiver 202,203,204,205 sequentially to save power and make the system more efficient. Turning now to FIG. 13, illustrated therein is an actuation circuit 1300 for doing so in accordance with embodiments of the invention. A corresponding timing diagram 1301 is also shown.

In the illustrative embodiment of FIG. 13, two clock signals are used—a first clock signal 1302 for causing the light emitting elements of each infrared transceiver to emit light, and a second clock 1303 for scanning the light receiving elements of each infrared transceiver. Where, for example, four infrared transceivers are used and three are used for triangulation, the second clock 1303 will be running at least three times the first clock 1302. As shown in the timing diagram 1301, in this illustrative embodiment, the infrared transceivers are driven serially, and the light emitting elements are scanned accordingly.

Turning now to FIG. 14, illustrated therein is another power saving circuit 1400 for use with embodiments of the invention. In FIG. 14, rather than scanning the light receiving elements of the infrared transceivers as was the case with the circuit (1300) of FIG. 13, the controller (214) is configured to determine object location or motion in response to an interrupt signal 1401. In one embodiment, the interrupt signal 1401 is generated by summing all the infrared transceiver outputs 1402,1403,1404,1405 and driving the light emitting elements of each infrared transceiver simultaneously. When a user's finger (701) or other object is present along the display surface (303), the interrupt signal 1401 is generated. Note that this configuration can be adapted by increasing the rate of light emission from each infrared transceiver when the interrupt signal 1401 indicates that the finger (701) or other object is present. Conversely, the rate of light emission can be decreased when nothing is present on the display surface (303) for extended amounts of time.

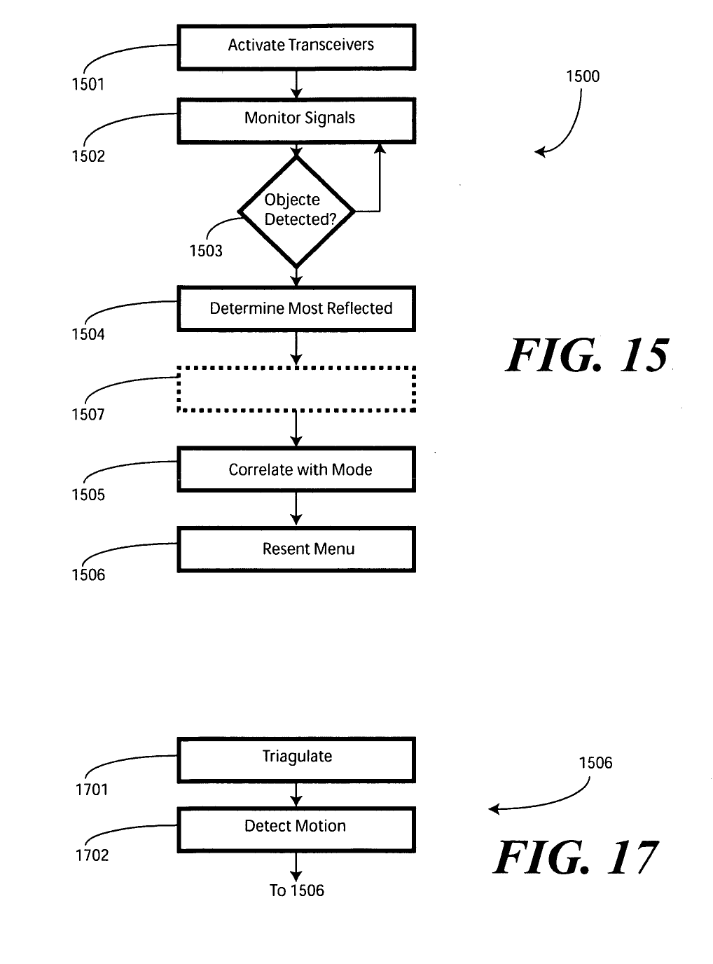

Turning now to FIG. 15, illustrated therein is one method 1500 for determining a user mode of operation in accordance with embodiments of the invention. The method 1500 of FIG. 15 is suitable, for example, for coding as computer executable instructions to be stored in a computer-readable medium in a portable electronic device. Such a computer-readable medium can be coupled to one or more processors, such as the controller (214) such that the method could be executed by the one or more processors to control the one or more processors to execute the method 1500.

At step 1501, at least four infrared transceivers, disposed about the perimeter of a display having a display surface, are actuated. These infrared transceivers can be actuated sequentially, such as by the circuit (1300) of FIG. 13, or alternatively simultaneously, such as by the circuit (1400) of FIG. 14.

At step 1502, the at least four infrared transceivers are monitored. Specifically, the light receiving elements of each infrared transceiver is monitored so that signal characteristics, such as signal strength, can be monitored. When an object is proximately located with the display surface, the reflected signals of the infrared transceivers change, thereby allowing a controller to determine that an object is present at decision 1503. At this step 1503, the controller receives, from four or more infrared transceivers disposed about the display, signals indicating reflection of infrared light from a user digit on the display.

At step 1504, the controller determines, from signals received from the at least four infrared transceivers, which infrared transceivers receives a most reflected infrared signal. In one embodiment, the controller determines which signal is indicative of most reflection.

Upon doing this, the controller can correlate this information with one of a plurality of user modes of operation at step 1505. In one embodiment, the controller correlates an infrared transceiver receiving the signal indicative of most reflection with a user's digit, stylus, or other object extending from one side of the display into the display

By way of example, where the display is a rectangle, and two infrared transceivers are disposed at the bottom of the display, and two are disposed at the top, the controller at steps 1504 and 1505 may scan the bottom infrared transceivers, where thumb blockage is likely to be present, and then can scan the top infrared transceivers. If the lower transceiver on the left has the most reflected signal and the upper transceiver on the left has the next highest signal, the controller can, in one embodiment, conclude the user is employing a single-handed, left-hand operational mode. Conversely, if the lower transceiver on the right has the most reflected signal and the upper transceiver on the right has the next highest signal, the controller can, in one embodiment, conclude the user is employing a single-handed, right-hand operational mode.

Once a particular blockage mode is identified, the display driver can present control menus on the display that are kept away from blocked portions of the screen at step 1506. Said differently, the display driver can present a menu of user selectable options on the display in a location that is based upon the one of the plurality of user modes of operation. In one embodiment, the display driver or controller can present an unobscured menu distally from the one side of the display corresponding to the transceiver having a most reflected signal. Where a first menu has already been presented, this step 1506 can include the presentation of a sub-menu corresponding to a selectable option from the first menu. Further, this sub-menu can be presented on the display about the user's finger, stylus, or other object.

Continuing the examples from above, where the user mode of operation is a right-handed mode of operation, upon correlating the right-handed mode of operation, the controller and display driver can present a menu of selectable options towards a left side of the display. Conversely, where the user mode of operation is a left-handed mode of operation, upon correlating the left-handed mode of operation, the controller and display driver can present the menu of selectable options toward a right side of the display. This is shown in FIG. 16.

Turning briefly to FIG. 16, one possible embodiment of the step 1506 of presenting a menu corresponding to a user mode of operation is shown. At decision 1601, the controller determines whether a right-handed mode of operation or left-handed mode of operation is being employed. Where the user mode of operation is a right-handed mode of operation, the controller and display driver can present a menu of selectable options towards a left side of the display at step 1602. Conversely, where the user mode of operation is a left-handed mode of operation, the controller and display driver can present the menu of selectable options toward a right side of the display at step 1603.

Turning now back to FIG. 15, in one embodiment, in addition to determining a user mode of operation, the controller can also determine object location or motion, illustrated as optional step 1507. Exemplary details of step 1507 are shown in FIG. 17.

Turning to FIG. 17, at step 1701, the controller can determine, for example, by triangulation of signals received from three of the at least four infrared transceivers, an object location of an object along a surface of the display. In one embodiment, the three infrared transceivers excludes the infrared transceiver receiving the most reflected infrared signal.

Where motion detection is desired, step 1702 can be employed. At step 1702, the controller detects motion by repeated triangulation of the signals received from three of the at least four infrared transceivers. In one embodiment, the three infrared transceivers excludes the infrared transceiver receiving the most reflected infrared signal. In one embodiment, the motion can be detected as the user moving a finger, stylus, or other object to a selectable option on the menu of selectable options presented on the display.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. An electronic device, comprising:
a display for presenting information to a user; and
an infrared detector, comprising:
at least four infrared transceivers disposed about the display such that light from the at least four infrared transceivers is projected across a surface of the display; and
a controller, operable with each of the at least four infrared transceivers, wherein the controller is configured to detect which of the at least four infrared transceivers receives a most reflected light signal, and to correlate an infrared transceiver receiving the most reflected light signal with one of a plurality of user modes of operation.

2. The electronic device of claim 1, wherein the controller is further configured to determine a location of an object along the surface by triangulation using signals received by at least three of the at least four infrared transceivers, wherein the at least three of the at least four infrared transceivers does not include the infrared transceiver receiving the most reflected light signal.

3. The electronic device of claim 2, wherein the display comprises a top and a bottom, wherein at least two of the at least four infrared transceivers are disposed along the bottom, wherein the controller is configured to detect which of the at least four infrared transceivers receives the most reflected light signal by detecting which of the at least two of the at least four infrared transceivers disposed along the bottom receives the most reflected light signal.

4. The electronic device of claim 3, further comprising determining whether an infrared transceiver disposed along the bottom receives the most reflected light signal receives a signal exceeding a predetermined threshold, wherein upon detecting the infrared transceiver disposed along the bottom receives the signal exceeding the predetermined threshold, the controller is configured to correlate the infrared transceiver receiving the most reflected light signal with one-handed user operation.

5. The electronic device of claim 3, wherein at least two of the at least four infrared transceivers are disposed along the top of the display, wherein the controller is further configured to detect which of the at least two of the at least four infrared transceivers disposed along the top of the display receives a upper transceiver most reflected light signal.

6. The electronic device of claim 5, wherein upon the controller detecting both which of the at least two of the at least four infrared transceivers disposed along the bottom of the display receives the most reflected light signal and which of the at least two of the at least four infrared transceivers disposed along the top of the display receives the upper transceiver most reflected light signal, the controller is configured to correlate a pair of infrared transceivers receiving the most reflected light signal and the upper transceiver most reflected light signal with one of a left-handed mode of operation or a right-handed mode of operation.

7. The electronic device of claim 6, further comprising:
a display driver, operable with the controller and configured to present a control menu to the user on the display;
wherein the display driver is configured to one of:
upon the controller correlating the pair of infrared transceivers receiving the most reflected light signal and the upper transceiver most reflected light signal with the left-handed mode of operation, present the control menu on a right-side portion of the display, or
upon the controller correlating the pair of infrared transceivers receiving the most reflected light signal and the upper transceiver most reflected light signal with the right-handed mode of operation, present the control menu on a left-side portion of the display.

8. The electronic device of claim 6, wherein each infrared transceiver comprises a light emitting element and a light receiving element, with the at least four infrared transceivers being disposed at corners of the display such that the light emitting element of each infrared transceiver projects light that intersects with light from other light emitting elements within a perimeter of the display.

9. The electronic device of claim 2, further comprising:
a display driver, operable with the controller and configured to present a control menu to the user on the display, wherein the display driver is configured to present the control menu on a portion of the display disposed distally from the infrared transceiver receiving the most reflected light signal.

10. The electronic device of claim 9, wherein the control menu comprises a plurality of selectable menu items, wherein more recently selected menu items are presented closer to the location of the object than less recently selected menu items.

11. The electronic device of claim 9, wherein in the display comprises a plurality of surface area segments with each surface area segment corresponding to each of the at least four infrared transceivers, wherein upon the controller detecting which of the at least four infrared transceivers receives the most reflected light signal, the display driver is configured to present the control menu in surface area segments other than a surface area segment corresponding to the infrared transceiver receiving the most reflected light signal.

12. The electronic device of claim 9, wherein the controller is further configured to determine movement of the object along the surface by repeated triangulation of the signals received by the at least three of the at least four infrared transceivers, wherein upon the controller detecting the movement of the object to a sub-portion of the control menu, the display driver is configured to present a second menu corresponding to the sub-portion contacted by the object about the object.

13. The electronic device of claim 12, wherein the display driver is configured to present the second menu about the object in a curved configuration.

14. The electronic device of claim 1, wherein the controller is configured to configure the electronic device in an operating mode corresponding to the user mode of operation.

15. The electronic device of claim 1, wherein each of the at least four infrared transceivers is disposed so as to project light at an acute angle relative to the surface of the display.

16. A computer-readable medium in a portable electronic device comprising a display and at least four infrared transceivers disposed about the display, the computer-readable medium including instructions for performing a method, when executed by a processor coupled with the computer-readable medium, for determining a user mode of operation, the method comprising:
determining, from signals received from the at least four infrared transceivers, which infrared transceivers receives a most reflected infrared signal;
correlating which infrared transceiver receives the most reflected infrared signal with one of a plurality of user modes of operation; and
presenting a menu of user selectable options on the display in a location based upon the one of the plurality of user modes of operation.

17. The computer-readable medium of claim 16, wherein the plurality of user modes of operation comprise a right-handed mode of operation and a left-handed mode of operation, wherein the method further comprises:
upon correlating the right-handed mode of operation, presenting the menu of selectable options towards a left side of the display; and
upon correlating the left-handed mode of operation, presenting the menu of selectable options toward a right side of the display.

18. The computer-readable medium of claim 16, further comprising:
determining, by triangulation of the signals received from three of the at least four infrared transceivers, the three of the at least four infrared transceivers excluding the infrared transceiver receiving the most reflected infrared signal, an object location of an object along a surface of the display.

19. The computer-readable medium of claim 18, further comprising:
determining, by repeated triangulation of the signals received from the three of the at least four infrared transceivers, movement of the object to a selectable option on the menu of selectable options, and
presenting a sub-menu corresponding to the selectable option on the display about the object.

20. A method, configured as embedded code operative with a processor in a portable communication device, for presenting an unobscured menu to a user on a display, the method comprising:
receiving, from four or more infrared transceivers disposed about the display, signals indicating reflection of infrared light from a user digit on the display;
determining which signal is indicative of most reflection;
correlating an infrared transceiver receiving the signal indicative of most reflection with the user digit extending from one side of the display into the display; and
presenting the unobscured menu distally from the one side of the display.
